(19) United States
(12) Patent Application Publication
(10) Pub. No.: US 2003/0227596 A1
(43) Pub. Date: Dec. 11, 2003

(54) Tinted contact lenses

(76) Inventors: Douglas G. Clark, Jacksonville, FL (US); Eric M. Gray, Jacksonville, FL (US); Lori N. Wishard, Ponte Vedra Beach, FL (US)

Correspondence Address: PHILIP S. JOHNSON, JOHNSON & JOHNSON, ONE JOHNSON & JOHNSON PLAZA, NEW BRUNSWICK, NJ, 08933-7003, US

(21) Appl. No.: 10/165,058

(22) Filed: Jun. 7, 2002

(51) Int. Cl. G02C 7/04

(52) U.S. Cl. 351/162

(57) ABSTRACT

The invention provides tinted contact lenses, and methods for their manufacture, that incorporate a mark to indicate that the lens is a diagnostic lens. The mark can be provided on a lens without interfering with the lens wearer's ability to assess the on-eye appearance of the lens. Additionally, the mark may be provided on the lens using pad printing technology.

### FIELD OF THE INVENTION

The invention relates to tinted contact lenses. In particular, the invention provides contact lenses that bear a mark indicating that the lenses are diagnostic lenses.

### BACKGROUND OF THE INVENTION

The use of tinted, or colored, contact lenses to alter the natural color of the iris is well known. Typically, diagnostic lenses, or lenses used for fit and cosmetic appearance evaluation purposes, are made available to the eye care practitioner. These lenses are intended to permit the practitioner to assess the on-eye fitting characteristics of the lens. Also, diagnostic lenses are intended to permit the wearer to assess the cosmetic appearance of the lens on-eye before a final lens is prescribed. The diagnostic lenses are not intended for regular use or sale.

Unfortunately, diagnostic lenses may be diverted from practitioners and sold outside of the normal channels of commerce. Additionally, the lens wearer may wear a diagnostic lens beyond the initial assessment period. To address these problems, it is known to mark diagnostic tinted lenses with a letter or word to indicate that they are intended as sample lenses only. For example, in EP 1162493 it is disclosed to mark a tinted lens outside of the iris pattern of the lens. This method is disadvantageous in that it may be incompatible with certain manufacturing processes. Additionally, a mark in that position may interfere with the wearer's ability to assess the appearance of the lens on eye. Therefore, a need exists for a mark that is useful on diagnostic lenses and that in addition overcomes these disadvantages.

### BRIEF DESCRIPTION OF THE DRAWINGS

FIG. 1 is a plan view of a first and preferred embodiment of the invention.

FIG. 2 is a plan view of a second embodiment of the invention.

FIG. 3 is a plan view of a third embodiment of the invention

FIG. 4 is a plan view of a fourth embodiment of the invention

### DETAILED DESCRIPTION OF THE INVENTION AND PREFERRED EMBODIMENTS

The invention provides tinted contact lenses, and methods for their manufacture, that incorporate a mark to indicate that the lens is a diagnostic lens. It is a discovery of the invention that such a mark can be provided on a lens without interfering with the lens wearer's ability to assess the on-eye appearance of the lens. Additionally, the mark of the invention may be provided on the lens using pad printing technology.

In one embodiment, the invention provides a contact lens comprising, consisting essentially of, and consisting of a color zone and at least one mark within the color zone. By “color zone” is meant the area of the lens that contains at least one color layer, at least one layer of shapes, or at least one layer of both, which zone covers all or a portion of the wearer's iris. By “mark” is meant one or more words, letters, symbols, shapes, or the like and combinations thereof. In a preferred embodiment, the mark is a word and preferably is the word “test”, “sample” or the like. The word may be in any type of font and in any language.

In the lenses of the invention, the mark is situated within the color zone. The color zone is an area of the lens that, when the lens is on-eye, overlays the wearer's iris. Preferably, the color zone is substantially circular in shape. The color zone may be composed of one or more layers of color that may be the same or different, one or more layers of shapes that may the same of different, or both. Additionally, the shapes may be colored including, without limitation, black or white, or voids of color. The shapes useful in the color zone may be arbitrary, geometric, or both. The color zone alters or enhances the natural color of the lens wearer's iris.

The mark may be located in any area within the color zone, but preferably is located at an area that is substantially at the periphery of the color zone to ensure that the mark does not interfere with the wearer's assessment of the lens on eye. By “substantially at the periphery of the color zone” is meant that the outer edges of the mark would touch a circle, the radius of which is greater than about 50 percent of the radius of a circle circumscribing the diameter of the color zone. Locating the mark in the preferred location permits positioning of the mark, when the lens is on-eye, by the eye care practitioner at approximately the 12 o'clock position along an axis that is generally parallel to the lens wearer's nose. A mark in this position will stay hidden under the wearer'eyelid for about 5 to 10 minutes providing sufficient time for the wearer to evaluate the lens on-eye. At the same time, due to the blinking of the lens wearer and concomitant rotation of the lens, the mark becomes visible after this time making the lens unattractive for prolonged periods of wear.

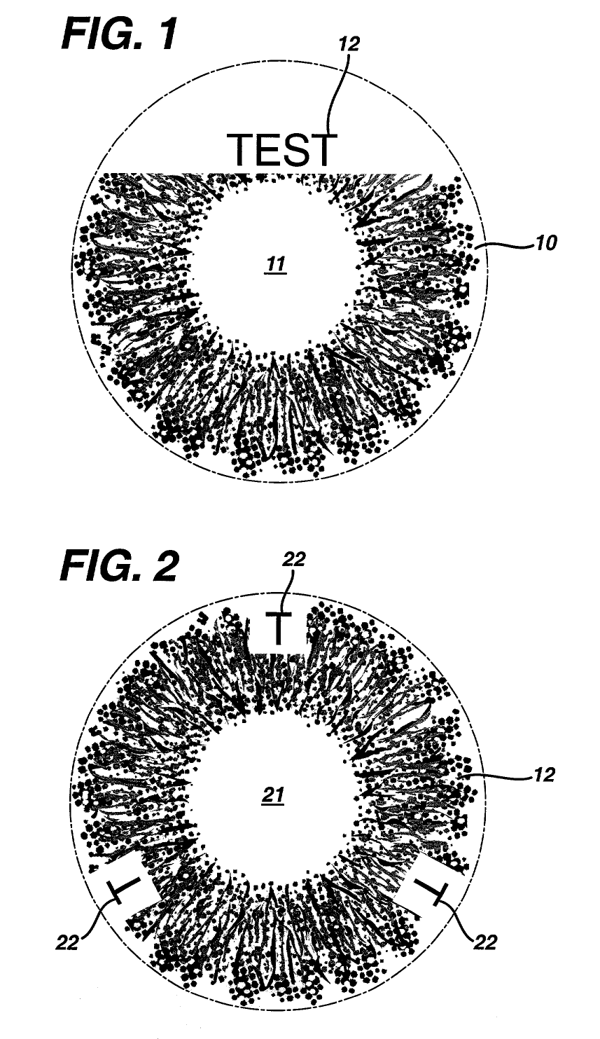

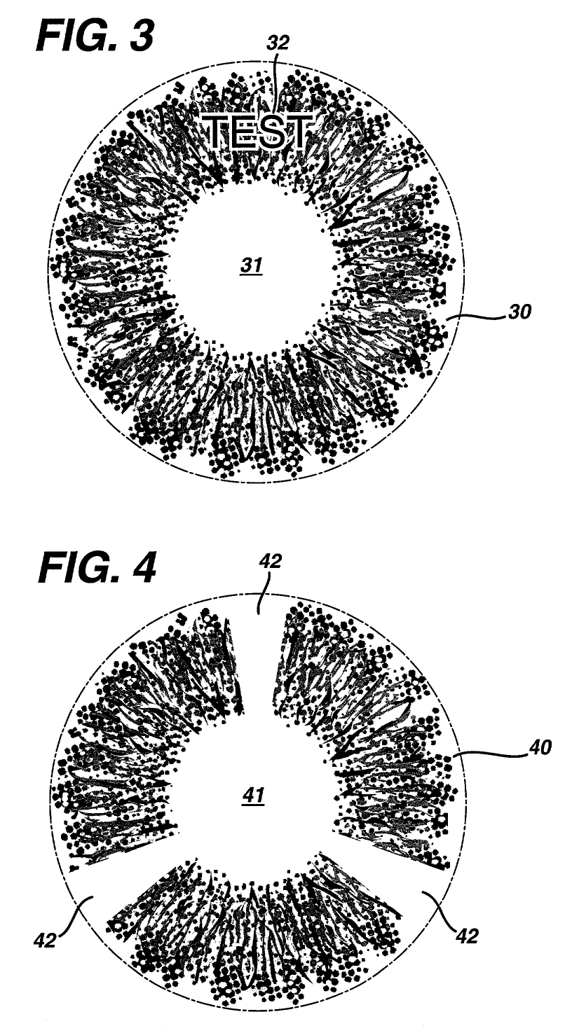

In FIG. 1 is depicted color zone 10, clear central zone or area 11 and mark 12 in an area of color zone 10 from which all of the color and shapes have been either removed or omitted. In FIG. 2 is depicted an alternative embodiment in which there is a color zone 20, a clear central zone 21, and multiple marks 22 within the color zone. In embodiments in which multiple marks are used, preferably, the marks are substantially equally spaced apart as depicted. In a second alternative embodiment, and as depicted in FIG. 3, color zone 30 and clear central area 31 are shown. Mark 32 is shown as a portion of the layers of the color zone. In FIG. 4 is depicted yet another alternative embodiment in which there is color zone 40 and a clear central area 41. Multiple marks 42 are shown which marks are shapes formed by the removal or omission of the color and shapes from portions of the color zone.

As illustrated by the foregoing examples, the mark may be printed as a portion of, or applied over, the color zone. Alternatively, and preferably, all or a portion of the color zone may be removed or omitted and the mark may be placed in the colorless area. In this embodiment, if the color zone is formed by multiple layers, not all of the layers need be removed, but only so much as necessary to render the mark visible to one observing the lens on-eye. Preferably, in this embodiment, about 2 to about 39%, more preferably about 12% to about 15% of the color zone is removed.

The mark used in the lenses of the invention may be of the same or a different color than the colors used in the color zone or it may be formed by the removal of omission of color as shown in FIG. 4. In embodiments in which the mark is colored, the mark may be either an opaque or a translucent mark. By “opaque” is meant a color that permits an average light transmittance ( % T) in the 380 to 780 nm range of 0 to about 55, preferably 7 to about 50 percent T. By “translucent” is meant a color that permits an average light transmittance (% T) in the 380 to 780 nm range of greater than or equal to about 60, preferably greater than or equal to about 65 percent T.

The marks of the invention may be applied to, or printed on, the lens by any convenient method. For example, the marks may be placed on the lens using the same process by which the color zone is applied. In a preferred method, a thermoplastic optical mold, made from any suitable material including, without limitation, cyclic polyolefins and polyolefins such as polypropylene or polystyrene resin may be used. The layers making up the color zone and the mark are deposited onto the desired portion of the molding surface of the mold. By “molding surface” is meant the surface of a mold or mold half used to form a surface of a lens. Deposition may be carried out by any convenient method including, without limitation, ink jet or pad printing, photographic means and the like, and combinations thereof. Preferably, the deposition is carried out by pad printing.

In an example of pad printing, a metal plate, preferably made from steel and more preferably from stainless steel, is covered with a photo resist material that is capable of becoming water insoluble once cured. The pattern of the color layer is selected or designed and then reduced as needed to the desired size using any of a number of techniques including, without limitation, photographic techniques, graphic arts techniques, and the like and combinations thereof, and placed over the metal plate. The photo resist material then is cured.

Following application of the pattern, the plate is subsequently washed with an aqueous solution and the resulting image is etched into the plate to a suitable depth, for example about 10 to about 20 microns. The mark may be included as a part of a layer of the color zone. In that case, the mark is created on the same metal plate and at the same time via the same process as the layer. Alternatively, the mark may be a unique feature that requires a separate layer. In this case, a separate design is provided for the mark and a separate metal plate is manufactured. As yet another alternative, a layer of the color zone may be designed without a pattern in an area or portion of the zone, meaning that there are no features etched into the metal plate over that area of the layer. The result, as printed on the lens, is that a blank or void is left in the color zone at that location. This may be accomplished with one or more layers or a multi-layer design. As desired, the void areas may be aligned with each other during the printing process to eliminate one or more or all color layers or shape layers from the desired portion of the color zone.

A colorant containing a binding polymer, solvent, and pigment or dye is then deposited onto the pattern to fill the depressions with colorant. A silicon pad of a geometry suitable for use in printing on the surface and varying in hardness, generally from about 1 to about 10 durometer, is pressed against the image on the plate to remove the colorant and the colorant is then dried slightly by evaporation of the solvent. The pad is then pressed against the molding surface of an optical mold to transfer the colorant and pattern. Upon completion of the printing process, the mold is degassed for up to 12 hours to remove excess solvents and oxygen after which the mold is filled with lens material. A complementary mold half is then used to complete the mold assembly and the mold assembly is exposed to conditions suitable to cure the lens material used. Such conditions are well known in the art and will depend upon the lens material selected. Once curing is completed and the lens is released from the mold, it is equilibrated in a buffered saline solution.

In a preferred embodiment of the invention that provides a color zone that substantially changes the appearance of the lens wearer's iris, a contact lens is provided that comprises a base layer, of a translucent color zone and a clear central zone, and one or more additional color layers selected from the group consisting of a second translucent color layer, an opaque color layer, or a combination thereof, each of the additional color layers comprising a clear central zone and a color zone, wherein at least one mark is located within the color zone. By “substantially changes” means that color of the iris is changed from its natural color, as for example, from blue to brown.

In another preferred embodiment in which the color zone substantially enhances the lens wearer's iris color, a translucent layer is provided as the color zone, the clear central zone is absent, and at least one mark is located within the color zone. By “substantially enhances” is meant that the wearer's iris color is modified as, for example, modified from light to dark blue.

In the embodiments of the invention, the color layers may be applied to either the back, or eye side, surface or the front, or object side, surface of the lens, or combinations thereof, but preferably all of the layers are on the front surface of the lens. Additionally, the layers may be applied, or printed, in any order. For example, the base layer may be applied: in front of one or more additional translucent layers, opaque layers, or both; behind one or more additional translucent layers, opaque layers, or both; or between one or more translucent layers, opaque layers, or both. Preferably, the base layer is the outermost color layer on the surface of the lens. In yet another embodiment, and preferably, a clear, pre-polymer layer may be used in conjunction with the color layers. One ordinarily skilled in the art will appreciate that any of a number of embodiments of the lenses of the invention are possible.

The mark as well as the color zones may be made from any organic or inorganic pigment suitable for use in contact lenses, or combinations of such pigments. The opacity may be controlled by varying the concentration of the pigment and titanium dioxide used, with higher amounts yielding greater opacity. Illustrative organic pigments include, without limitation, pthalocyanine blue, pthalocyanine green, carbazole violet, vat orange #1, and the like and combinations thereof. Examples of useful inorganic pigments include, without limitation, iron oxide black, iron oxide brown, iron oxide yellow, iron oxide red, titanium dioxide, and the like, and combinations thereof. In addition to these pigments, soluble and non-soluble dyes may be used including, without limitation, dichlorotriazine and vinyl sulfone-based dyes. Useful dyes and pigments are commercially available.

The dye or pigment selected may be combined with one or more of a prepolymer, or binding polymer, and a solvent to form the colorant used to produce the translucent and opaque layers used in the lenses of the invention. The pre-polymer may be any polymer that is capable of dispersing the pigment and any opacifying agent used. Other additives useful in contact lens colorants also may be used. The binding polymers, solvents, and other additives useful in the color layers of the invention are known and either commercially available or methods for their making are known.

In the lenses of the invention, in addition to the first base layer of the color zone, one or more additional color layers may be used. The base layer also may be replaced with a layer of translucent color. In either embodiment, the additional layers may be one or more translucent color layers, one or more layers of opaque color, or combinations thereof. In one preferred embodiment, two opaque color layers or a second translucent color layer and an opaque color layer are used. Each of the additional color layers must be of a color that is the same as, similar to, or complementary to, the color of the base layer and aids in achieving the color change desired for the natural iris. In another preferred embodiment, one additional translucent color layer or one additional opaque color layer is used. In yet another preferred embodiment, an additional layer is used that is a clear prepolymer layer, which prepolymer layer is on the front, or object side, surface of the lens.

The color zones of the additional translucent layers, opaque layers, or both may be of a uniform density or radially gradient in appearance. By “radially gradient” is meant that although the color density of any shapes forming the layer does not vary, the size, density, and placement of the shapes within the zone vary such that a radially gradient effect is produced. The color zone may contain any of a number of shapes including, without limitation, circles, ovals, rectangles, triangles, lines, striae, feather-like shapes, and the like and combinations thereof. The color layer of each zone may include areas void of color including, without limitation, areas without color and areas resulting from the creation of an appearance of radially gradient variation in density

One or more layers of opaque color also may be used in the lens of the invention. The color zones of the opaque layer or layers may be uniform or have a radially gradient appearance meaning that, although the opaque color density does not vary, the size, density, and placement of opaquely colored shapes within the zone vary such that a radially gradient effect is produced. The uniform color zones may include clear shapes, the shapes including, without limitation, circles, ovals, triangles, lines, striae, feather-like shapes, and the like, and combinations thereof. Alternatively, the color zone may be composed of opaquely colored shapes, such as those listed.

The invention may be used to provide tinted hard or soft contact lenses made of any known lens-forming material, or material suitable for manufacturing such lenses. Preferably, the lenses of the invention are soft contact lenses and the material selected for forming the lenses of the invention may be any material suitable for producing soft contact lenses. Suitable preferred materials for forming soft contact lenses using the method of the invention include, without limitation, silicone elastomers, silicone-containing macromers including, without limitation, those disclosed in U.S. Pat. Nos. 5,371,147, 5,314,960, and 5,057,578 incorporated in their entireties herein by reference, hydrogels, silicone-containing hydrogels, and the like and combinations thereof. More preferably, the surface is a siloxane, or contains a siloxane functionality, including, without limitation, polydimethyl siloxane macromers, methacryloxypropyl polyalkyl siloxanes, and mixtures thereof, silicone hydrogel or a hydrogel, made of monomers containing hydroxy groups, carboxyl groups, or both or be made from silicone-containing polymers, such as siloxanes, hydrogels, silicone hydrogels, and combinations thereof. Materials for making soft contact lenses are well known and commercially available. Preferably, the material is acquafilcon, etafilcon, genfilcon, or lenefilcon.

What is claimed is:

1. A contact lens comprising a color zone and at least one mark within the color zone.

2. The lens of claim 1, wherein the mark is located in an area substantially at the periphery of the color zone.

3. The lens of claim 1, wherein a plurality of marks are within the color zone.

4. The lens of claim 3, wherein the plurality of marks are substantially equally spaced apart.

5. A contact lens comprising a color zone selected from the group consisting of at least one color layer, at least one layer of shapes, or both and at least one mark within the color zone.

6. The lens of claim 5, wherein the mark is located in an area substantially at the periphery of the color zone.

7. The lens of claim 6, wherein the mark is located in an area of the color zone from which substantially all of the at least one color layer is removed.

8. The lens of claim 6, wherein the mark is located in an area of the color zone from which substantially all of the at least one layer of shapes is removed.

9. The lens of claim 6, wherein the mark is located in an area of the color zone from which substantially all of the at least one color layer and the at least one layer of shapes are removed.

10. The lens of claim 6, wherein the mark is located in an area of the color zone from which about 2 to about 39% of the at least one color layer is removed.

11. The lens of claim 6, wherein the mark is located in an area of the color zone from which about 2 to about 39% of the at least one layer of shapes is removed.

12. The lens of claim 6, wherein the mark is located in an area of the color zone from which about 2 to about 39% of the at least one color layer and the at least one layer of shapes are removed.

13. A contact lens, comprising a base layer having a clear central zone and a translucent color zone and one or more additional layers selected from the group consisting essentially of a second translucent color layer, an opaque layer, or a combination thereof and at least one mark within the color zone.

14. A contact lens, comprising a base layer having a clear central zone and an opaque color zone and one or more additional layers selected from the group consisting essentially of a second translucent color layer, an opaque layer, or a combination thereof and at least one mark within the color zone.

15. A contact lens, comprising a translucent color zone and one or more additional layers selected from the group consisting essentially of a second translucent color layer, an opaque layer, or a combination thereof and at least one mark within the color zone.

16. A contact lens, comprising a color zone comprising an opaque color zone and one or more additional color layers selected from the group consisting essentially of a second translucent color layer, an opaque layer, or a combination thereof and at least one mark within the color zone.

17. A contact lens, comprising a color zone comprising a translucent color zone and at least one mark within the color zone.

18. The lens of claim 13, 14, 15, 16 or 17, wherein the mark is located in an area of the color zone from which substantially all of the color is removed.

19. The lens of claim 13, 14, 15, 16 or 17, wherein the mark is located in an area of the color zone from which about 2 to about 39% of the color is removed.

20. The lens of claim 1, wherein a plurality of marks are within the color zone.

21. The lens of claim 20, wherein the plurality of marks are substantially equally spaced apart.

22. A method for manufacturing a tinted contact lens, comprising the step of: depositing onto a surface of a lens a base layer having a clear central zone and a translucent color zone and one or more additional layers selected from the group consisting of a second translucent color zone, an opaque color zone, or a combination thereof and at least one mark within the color zone.

23. A method for manufacturing a tinted contact lens, comprising the step of: depositing onto a surface of a lens a base layer having a clear central zone and an opaque color zone and one or more additional layers selected from the group consisting of a second translucent color zone, an opaque color zone, or a combination thereof and at least one mark within the color zone.

24. A method for manufacturing a tinted contact lens, comprising the step of: depositing onto a surface a color zone comprising a translucent color zone and one or more additional layers selected from the group consisting of a second translucent color zone, an opaque color zone, or a combination thereof and at least one mark within the color zone.

25. A method for manufacturing a tinted contact lens, comprising the step of: depositing onto a surface a color zone comprising of an opaque color zone and one or more additional layers selected from the group consisting of a second translucent color zone, an opaque color zone, or a combination thereof and at least one mark within the color zone.

26. A method for manufacturing a tinted contact lens, comprising the step of depositing onto a surface a color zone comprising a translucent color zone and at least one mark within the color zone.

27. The method of claims 22, 23, 24, 25 and 26 wherein the deposition is carried out by pad printing.
